(19) United States
(12) Patent Application Publication
(10) Pub. No.: US 2010/0185700 A1
(43) Pub. Date: Jul. 22, 2010

(54) METHOD AND SYSTEM FOR ALIGNING ONTOLOGIES USING ANNOTATION EXCHANGE

(76) Inventor: Yan Bodain, Montreal (CA)

Correspondence Address: Miltons IP/p.i., 225 Metcalfe Street, Suite 700, Ottawa, ON, K2P 1P9, CA

(21) Appl. No.: 12/678,603

(22) PCT Filed: Sep. 17, 2008
(86) PCT No.: PCT/CA08/01632

§ 371 Date: Mar. 17, 2010

Related U.S. Application Data
(63) Continuation-in-part of application No. 11/898,814, filed on Sep. 17, 2007, now abandoned.

(51) Int. Cl. G06F 17/30

(52) U.S. Cl. 707/803; 707/E17.044

(57) ABSTRACT

Ontology alignment is achieved using an exchange of annotations between different actors (users, software agent, application, etc.) over the Internet in order to create aligned ontologies that can be used by search engines to locate web content in the Semantic Web. An annotation related to a source ontology is received from a different storage medium. The ontology associated with that annotation is retrieved in order to make a local copy. The copied ontology is renamed before its content can be modified through a user interface. Every element modified inside the copied ontology is then automatically tagged with information in that links the modified element to the corresponding element in the source ontology. Alignment between the copied ontology and the source ontology is thereby achieved.

### FIELD OF INVENTION

The present invention relates to computers, and more particularly to the use of annotation exchanges to create aligned ontologies that can be used by search engines to locate web content in the Semantic Web.

### REFERENCES CITED

BERLIN, J., MOTRO, A. (2002). Database Schema Matching Using Machine Learning with Feature Selection. In Proc. of the 14th Int. Conf. on Advanced Information Systems Eng. (CAiSE 02), LNCS 2348, Springer-Verlag, pp. 452-466.
BERLIN, J., MOTRO, A. (2001). Autoplex: Automated Discovery of Content for Virtual Databases. In Proc. of the Int. Conf. on Cooperative Information Systems (CoopIS), pp.108-122
BERNERS-LEE, T. (1998), What the Semantic Web can represent. Parenthetical discussion to the Web Architecture at 50,000 feet and the Semantic Web roadmap. [http://www.w3.org/DesignIssues/RDFnot.html]
CASTANO, S., DE ANTONELLIS, V. (1999). A Schema Analysis and Reconciliation Tool Environment. In Proc. of the 1999 Int. Symposium on Database Engineering & Applications (IDEAS), pp. 53-62
CLIFTON, C., HOUSMAN, E., ROSENTHAL, A. (1997). Experience with a combined approach to attribute-matching across heterogeneous databases. In Proc. of the IFIP Working Conference on Data Semantics (DS-7), pp. 429-451.
CRUZ, I. F., SUNNA, W., MAKAR, N., BATHALA, S. (2007). A visual tool for ontology alignment to enable geospatial interoperability. In Journal of Visual Languages and Computing & Computing, No.18, pp. 230-254
DO, H., AND RAHM, E. (2002). Coma: A system for fexible combination of schema matching approaches. In Proceedings of the 28th Conf. on Very Large Databases (VLDB).
DOAN, A., MADHAVAN, J., DHAMANKAR, R., DOMINGOS, P., HALEVY, A. (2003). Learning to Match Ontologies on the Semantic Web. In The Int. Journal on Very Large Data Bases (VLDB), Vol.12, No.4,303-319.
DOAN, A. H., DOMINGOS, P., HALEVY, A. (2001). Reconciling Schemas of Disparate Data Sources: A Machine-Learning Approach. In Proc. of the ACM SIGMOD Conf. on Management of Data, pp. 509-520
GUARINO, N. (1998) Formal Ontology and Information Systems. In N. Guarino, (Ed.) Formal Ontology in Information Systems. IOS Press, Amsterdam, Netherlands. pp. 3-15
KLEIN, M. (2001). Combining and Relating Ontologies: An Analysis of Problems and Solutions. In Workshop on Ontologies and Information Sharing (IJCAI-2001), Seattle, USA, pp. 309-327
KOTIS, K., VOUROS, G. A., STERGIOU, K. (2006). Towards automatic merging of domain ontologies: The HCONE-merge approach. In Elsevier's Journal of Web Semantics (JWS), Vol. 4, No. 1, pp. 60-79
LI, W. S., CLIFTON, C. (1994). Semantic Integration in Heterogeneous Databases Using Neural Networks. In Proc. of the 20th Int. Conf. on Very Large Data Bases (VLDB), pp. 1-12
LI, W. S., CLIFTON, C. (2000). SemInt: A Tool for Identifying Attribute Correspondences in Heterogeneous Databases Using Neural Network. In Data and Knowledge Engineering, Vol. 33, No. 1, pp. 49-84
MADHAVAN, J., BERNSTEIN, P. A., RAHM, E. (2001). Generic schema matching using Cupid. In Proc. of the 27th International Conference on Very Large Data Bases, pp. 49-58
MELNIK, S., GARCIA-MOLINA, H., RAHM, E. (2002). Similarity Flooding: A Versatile Graph Matching Algorithm. In Proc. of the 18th Int. Conf. on Data Engineering (ICDE), San Jose, Calif., USA, pp. 117-128
MILLER, R. J. et al. (2001). The Clio Project: Managing Heterogeneity. In ACM SIGMOD Record, Vol.30, No.1, pp. 78-83
MILO, T., ZOHAR, S. (1998). Using Schema Matching to Simplify Heterogeneous Data Translation. In Proc. of the 24 Int. Conf. on Very Large Data Bases (VLDB), pp. 122-133
MITRA, P., WIEDERHOLD, G., JANNINK, J. (1999). Semi-automatic Integration of Knowledge Sources. In Proc. of Fusion'99, Sunnyvale, Calif., USA.
NOY, N. F., MUSEN, M. A. (2000). PROMPT: algorithm and tool for automated ontology merging and alignment. In Proc. of the Seventeenth National Conference on Artificial Intelligence and Twelfth Conference on Innovative Applications of Artificial Intelligence (AAAI), Austin, Tex., pp. 450-455
OWL (Web Ontology Language), http://www.w3.org/TR/owl-features/
PALOPOLI, L., TERRACINA, G., URSINO, D. (2000). The System DIKE: towards the semi-automatic synthesis of Cooperative Information Systems and Data Warehouse. In Proc. Int. Symposium on Advances in Databases and Information Systems, Prague, pp. 108-117
RDF (Resource Description Framework), http://www.w3.org/RDF
RDFa syntax, http://www.w3.org/2006/07/SWD/RDFa/syntax/
SEMANTIC WEB, http://www.w3.org/2001/sw/SHVAIKO,
P., EUZENAT, J. (2005). A survey of schema-based matching approaches. In Journal on Data Semantics, Vol.4, pp. 146-171
STUMME, G., MAEDCHE, A. (2001). FCA-Merge: Bottom-up merging of ontologies. In Proc. of the 17th Int. Joint Conference Conf. on Artificial Intelligence (IJCAI '01), USA, pp. 225-230

The content of each and every one of these references is incorporated herein by reference.

### BACKGROUND OF THE INVENTION

The web has been organized using syntactic and structural methods. Consequently, most major applications such as search, personalization, advertisements, and e-commerce, utilize syntactic and structural methods and apparatus. Directory services, such as those offered by Yahoo!, offer a limited form of semantics by organizing content by category or subjects, but the use of context and domain semantics is minimal. When semantics is applied, critical work is done by humans (also termed editors or cataloguers), and very limited, if any, domain specific information is captured.

Current search engines rely on syntactic and structural methods. The use of keywords and corresponding search techniques that utilize indices and textual information without associated context or semantic information is an example of such syntactic method. Use of these syntactic methods in information retrieval is the most common way of searching today. Unfortunately, most search engines produce up to hundreds of thousands of results because the search context is not specified and ambiguities are hard to resolve. One way of enhancing a search request is using Boolean and other operators like “+/−” or “NEAR” whereby the number of resulting pages can be significantly reduced. However, the results still may bear little resemblance to what the user is looking for.

Most search engines and web directories use advanced searching techniques to reduce the number of results (recall) and improve the quality of the results (precision). Some search methods utilize structural information, including the location of a word or text within a document or site, the numbers of times the users have choose to view a specific results associated with a word, the number of links made to a page or web site, and whether the text is associated with a tag or attributes (such as title, media type, time). In a few cases when domain specific attributes are supported (as in the genre of music), the search is limited to one domain or one site (i.e. Amazon.com). It may also be limited to one purpose, such as product price comparison.

Grouping search results by web sites, as some search engines like Excite offer, can make it easier to browse through the often vast number of results. NorthernLight takes this idea further by providing a way of organizing search results into so-called “buckets” of related information (such as “Thanksgiving”, “Middle East” & “Turkey”, . . . ). Neither approach improves the search quality per se, but they facilitate the navigation through the search results.

Directory services support browsing with a limited set of attributes. When domain information is captured, a host of people (over 1000 at one company providing directing services and over 200 at another) classifies new and old web pages, to ensure the quality of those information. This is an extremely human-intensive process. The human cataloguers or editors use hundreds of classification or keyword terms that are mostly proprietary to that company. Considering the size and growth rate of the World Wide Web, it seems almost impossible to index a “reasonable” percentage of the available information by hand. While web crawlers can reach and scan documents in the farthest locations, the classification of structurally very different documents has been the main obstacle of building a metabase that allows the desired comprehensive attribute search against heterogeneous data.

The context of a search request is necessary to resolve ambiguities in the search terms that the user enters. For instance, a digital media search for “windows instructions” in the context of “computer technology”’ should find audio/video files about how to use windowing operation systems in general or Microsoft Windows in particular. However, the same search in the context of “home and garden” is expected to lead to instructional videos about how to install a window in your home.

Due to the unstructured and heterogeneous nature of the web resources, every web site uses a different terminology to describe similar things. A semantic mapping of terms is then necessary to ensure that the search systems serve documents within the same context in which the user has made his search.

Current manual or automated content acquisition may use metatags that are part of an HTML page, but these are proprietary and have no contextual meaning for general search applications.

Research in heterogeneous database management and information systems have addressed the issues of syntax, structure and semantics, and have developed techniques to integrate data from multiple databases and data sources. Large scale scaling and associated automation has, however, not been achieved yet. One key issue in supporting semantics is that of understanding the context of use.

Semantics can be directly incorporated into document by using Resource Description Framework (RDF). RDF was originally designed as a metadata model but has come to be used as a general method of modeling information, through a variety of different syntax formats. RDF has been developed by the World Wide Web Consortium and more information is available in the Internet.

The RDF metadata model is based upon the idea of making statements about resources in the form of subject-predicate-object expressions, called triples in RDF terminology. The subject denotes the resource, while the predicate denotes traits or aspects of the resource and expresses a relationship between the subject and the object. For example, one way to represent the notion “The sky has a blue color” in RDF is as a triple of specially formatted strings with a subject denoting “sky”, a predicate denoting “hasColor”, and an object denoting “blue”. Thus, RDF can be used to make semantic descriptions of web resource. However, RDF does not contain any ontological model.

The product of an attempt to formulate an exhaustive and rigorous conceptual categorization about a domain is described as “ontology”. An ontology is typically a hierarchical data structure containing all the relevant entities and their relationships and rules within that domain. Basic concepts of ontology include 1) classes of instances/things, 2) properties, 3) relations between the classes.

Prior art ontology systems include OWL (Web Ontology Language) which has a vocabulary for describing properties and classes, ranges, domains and cardinality restrictions on domains and co-domains, relations between classes (e.g. disjointness), equality and enumerated classes. Information about OWL is available in the Internet at http://www.w3.org/TR/owl-features/.

In summary, RDF can be used to describe web content while OWL can be used to express ontological concepts. The use of RDF and OWL together is problematic because there is no widespread adoption of these standards for page and site creators. These standards must be used before appropriate agents can be written. Even then, existing content cannot be indexed, catalogued, or extracted to make it a part of what is called a “Semantic Web”.

The concept of a Semantic Web is an important step forward in supporting higher precision, relevance and timeliness in using web-accessible content. The Semantic Web provides a common framework that allows data to be shared and reused across application, enterprise, and community boundaries. It is a collaborative effort led by W3C with participation from a large number of researchers and industrial partners. Information about the Semantic Web is available in the Internet.

Currently, syntax and structure-based methods pervade the entire web (both in its creation and the applications realized over it). The challenge has been to include semantic descriptions while creating content as required by current proposals for the Semantic Web. These semantic descriptions should refer to ontologies in order to define the precise meaning of web content. Because many different ontologies can be use to describe the same thing, it is actually very important to develop a means to facilitate the alignment of equivalent concepts originating in different ontologies.

An automatic alignment between different ontologies can be achieved using many different types of software: Agreement Maker [Cruz, 2007], Autoplex [Berlin, 2001], Automatch [Berlin, 2002], Clio [Miller, 2001], COMA [Do, 2002], Cupid [Madhavan, 2001], Delta [Clifton, 1996], DIKE [Palopoli, 2000], EJX [Li, 1994], FCA-Merge [Stumme, 2001], GLUE [Doan, 2003], HCONE-Merge [Kotis, 2006], LSD [Doan, 2001], MOMIS [Castano, 1999], PROMPT [Noy, 2000], SemInt [Li, 2000], SKAT [Mitra, 1999], Similarity Flooding [Melnik, 2002] et TranScm [Milo, 1998].

These programs use different techniques which are based on string, taxonomy, language, model, constraint, graph, linguistic resource, alignment reuse, upper level format ontologies, or repository of structures [Shvaiko, 2005]. None of these techniques is however totally efficient as they all suffer from many different problems: versioning (identification, tracebility, translation), practical problems (finding alignments, diagnosis, repeatability), mismatches between ontologies due to different language level (syntax, logical representation, semantics of primitives, language expressivity) or different ontology level. This problem of ontology level can by itself be related to problems in the conceptualization (coverage, concept scope) or the explication (terminology, modeling style, encoding) [Klein, 2001].

This problem of ontology level is extremely difficult to overcome. The coverage of the different ontologies is rarely equivalent because some ontologies converge general concepts while others converge more specific knowledge. Ontologies can thus be grouped into four different categories [Guariano, 1998]. The “top-level ontologies” use general concepts independent of any particular domain (ex: concept of space, time, event). This kind of ontology acts as a reference for the “domain ontologies” and the “task ontologies” defined by particular knowledge. The “domain ontologies” are defined by concepts specialized to a particular domain of activity. The “task ontologies” are defined by concepts related to the execution of a task in a context of a generic activity. Finally, both “domain ontologies” and “task ontologies” act as reference for the “application ontologies” defined by the concepts being used by the different actors of a domain implied in a specific context of activity. To resume, each ontology found on the web could be associated to one of the four preceding categories. The different levels of description associated with each category make ontology alignment even more difficult.

No software can produce a perfect alignment between different ontologies in an automatic manner. A perfect alignment can only be obtained by the means of a human being doing the task. This solution is, however, extremely difficult to implement partly because of the sheer size of the ontologies and the inherent complexity of this task. Moreover, no human expert will never match the 100,000 ontologies that are actually indexed by Swoogle. This number is also expected to increase in the years to come.

The difficulty of building a common consensus in the definition of the different ontologies (even in their most general form like the “top-level ontologies”) is also very real. For example, if we want to define the concept of “husband” and “wife”, we would probably use a rule that specifies that one husband is related to one and only one wife. This relation could always be challenged by someone who does not recognize the monogamy concept (so one husband could also be related to one or many wifes). The same kind of problem can occur in many different situations. For example, if we agree to define the concept of “desert” as a place where the water is rare, then it will be extremely difficult to define the concept of “desert of snow” which is made entirely of crystallized water. Thus, a consensus in the definition of the ontologies is not always possible.

It is actually extremely difficult to define some universal ontologies that could act as authoritative references for the Semantic Web. However, the aim of the Semantic Web is not to define the exact meaning of the concepts being used on the web but rather to help the machines assist humans in finding those concepts [Berners-Lee, 1998]. In this way, it is not really important that the concepts found in the different ontologies are perfectly correct, but rather that they are simply useful for support human activities.

What is needed is an improved method and system for achieving a relative alignment between the concepts found in different ontologies on the web while, at the same time, preserving possible disagreements that can be expressed in the conception of those ontologies in order to help search engines find the most suitable content for end users on the Semantic Web.

### SUMMARY OF THE INVENTION

The present invention provides a method of aligning ontologies using annotation exchange in a computer environment in which a plurality of storage media are connected for intercommunication over a plurality of networks, each storage medium storing annotations received from other storage media and ontologies associated with each said annotation, the method comprising the steps of: receiving at a first storage medium an annotation associated with a source ontology; retrieving at least a partial copy of said source ontology; renaming said retrieved ontology; modifying the renamed ontology in accordance with each element changed by an actor that modifies at least one element of the renamed ontology; inserting a reference in said modified renamed ontology that links said each said changed element to a corresponding element in said source ontology, in order to track a difference between the renamed ontology and the source ontology; and storing said modified renamed ontology.

The present invention further provides computer-readable medium containing tangibly embodied executable code that when executed by a user device instantiates a user interface adapted to be used by said actor to perform the method of aligning ontologies using annotation exchange.

The invention yet further provides computer-readable medium containing tangibly embodied executable code that when executed by a server enables an actor to perform the method of aligning ontologies using annotation exchange.

### Preferred Features of the Invention

This alignment of ontologies is based on annotations that are shared by different actors and by the modifications that each actor decides to contribute to the ontology. Since the ontologies are physically independent from each other, any change made to one ontology will not be propagated to other ontologies. This disposition lets different actors state different opinions without requesting synchronization between the different ontologies. The alignment of ontologies is made indirectly by links referencing the corresponding class in each different ontology. The fact that these ontologies were used by different people sharing at least one common content (annotation) should guarantee that the shared concepts will be relatively close to each other.

The present invention provides for a method of constructing ontologies in a bottom-up approach, by letting individual actors create ontology classes without requiring a well organized team of knowledge engineers.

The present invention provides a distributed ontology, built from individual efforts distributed over the Internet, which in aggregate comprise a global ontology that can be used to locate content. The physical distribution of different parts of the ontology is arbitrary, and the different parts may reside on the same physical computer or on different physical computers.

The present invention also includes the ability to develop an indirect consensus in an ontology definition by letting every actor decide to use or reject an imported ontology element in its own document and to participate, in this way, in the construction of a common structure of ontology that can be indirectly discovered by search engines on the Semantic Web.

Every copy of the shared ontology can be modified by incorporating parts from others ontologies. If these parts already have some indirect link to other ontologies, then the overall effect will be a dramatic increase in the overall size of the alignment grid. Such a huge grid could then used by a software agent to optimize a search.

A preferred embodiment of the present invention includes a novel method for producing a description of a web site by building an index of the available contents related to an ontology. This index takes the form of a hierarchy of concepts enumerating the physical position of each concept inside the web site. This index helps end users rapidly find all the contents having been annotated by directly selecting a corresponding ontological concept. The preferred embodiment of the present invention creates an index in a machine processable format (RDF, OWL) as well as in a human consumable format (HTML).

The index used in the preferred embodiment of the present invention is published in HTML and implies that the value of the annotation will be visible to all web users. The author of the document is then obligated to validate the value of the annotation and to decide if the modification that he will undertake will make sense to end users.

The links between the different ontologies constitute a global ontology that can be used by search engines to locate web content in the Semantic Web. Moreover, these links can also be used to give a feedback to each actor involved in the modification of the ontology respecting the nature of the changes made by others. This could help to forge an active consensus between the different actors while maintaining the liberty of each one to agree about the changes made by others. This feedback could dramatically increase the coherence of the different ontologies on the Semantic Web.

The present invention generates semantic descriptions that form the basis for implementing a Semantic Web as well as for developing methods to support applications for the Semantic Web, including semantic search, semantic profiling and semantic advertisement. For example, semantic descriptions may be exchanged and utilized between partners, including a content owner (or content syndicate or distributor), destination sites (or the sites visited by users), and advertisers (or advertisement distributors or syndicates), to improve the value of content ownership, advertisement space (impressions), and advertisement charges.

The present invention also provides the ability to create a community of practice by exploiting the indirect links created between ontologies by the annotations to find users who share the same common interest.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrate one embodiment of the invention and together with the description, serve to explain the principles of the invention.

FIG. 1 is a bloc diagram depicting the internal structure of a programmable processing system.

FIG. 2 is a diagram of an operating environment according to an exemplary embodiment of the present invention.

FIG. 3 is a block diagram of a repository according to an exemplary embodiment of the present invention.

FIG. 4 illustrates an example of RDF triples stored inside a repository.

FIG. 5 illustrates an example of an OWL ontology.

FIG. 6-7-8 graphically depict the process of enhancing a document with an annotation in order to retrieve the corresponding ontology and creating an alignment between different ontologies in other to let search engines to locate contents on the Semantic Web.

FIG. 9 illustrates the RDF model before the exchange of annotations.

FIG. 10 illustrates the resulting RDF model after the exchange of annotations.

FIG. 11-12 present a preferred embodiment for the graphics user interface.

FIG. 13 presents a preferred embodiment for HTML page output.

FIG. 14 illustrates a preferred embodiment for the RDF description file created to describe the web pages.

FIG. 15 illustrates a preferred embodiment for HTML index created to link the content of the ontology to the corresponding annotation.

FIG. 16 illustrates the architecture of the preferred embodiment of the present invention.

FIG. 17 illustrates the ontology alignment being used by search engine on the Semantic Web.

FIG. 18 graphically summarizes the process of using annotations as means of creating an ontology alignment on the Semantic Web.

### DETAILED DESCRIPTION OF THE PREFERRED EMBODIMENT

A preferred embodiment of the invention is now described in detail. Referring to the drawings, like numbers indicate like parts throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. In the foregoing discussion, the following terms will have the following definitions unless the context clearly dictates otherwise.
Actor: a person or process that supplies a stimulus to a system. For example: human user, software agent, application, etc.
Agent: software that acts for a user or other program in a relationship of agency. Such “action on behalf of” implies the authority to decide when (and if) action is appropriate. The idea is that agents are not strictly invoked for a task, but activate themselves.
Annotation: information that can be associated with content to provide extra information. For example, an ontology class can be associated to a web content to produce an annotation.
Class: a set of real world entities whose elements have a common classification; e.g., a class called Book is the set of all books in existence.
Content: data, data sets, text, semi-structured text, image, audio, video, animations, including TV and radio content potentially delivered on Internet.
Database: a collection of tables, each having one or more fields, in which fields of a table may point to other tables.
Domain: a comprehensive modeling of information (including digital media and all data or information such as those accessible in the web) with the broadest variety of metadata possible.
Ontology: a universe of subjects or terms (also, categories and attributes) and relationships between them, often organized in a hierarchical structure; includes a commitment to uniformly use the terms in a discourse in which the ontology is subscribed to or used.
OWL: (Web Ontology Language), a specification developed by the W3C for making ontological statements. OWL is developed as a vocabulary extension of RDF.
RDF: (Resource Description Framework), a specification developed by the W3C for representing resources in the web. RDF is a directed, labeled graph data format. It allows the description of web resources by using “triple” (subject-predicate-object) statement. RDF can be expressed in XML as well as other formats (Turtle, Notation 3, etc.).
RDFa: (Resource Description Framework attributes), a specification developed by the W3C for representing RDF resources inside a XHTML page.
Repository: a storage medium where data are stored and maintained. A repository can be a place where multiple databases, files, records or data are located for distribution. A repository could possibly be created with or without a socket or a network connection. For example, a repository could be a location in the memory of a computer for supporting a program execution or, more simply, a file located on a web server.
Semantic advertising: utilizing semantics to target advertising to users (utilizing semantic-based information such as that available from semantic search or semantic profiling).
Semantic browsing and querying: a method of combining browsing and querying to specify search for information that also utilizes semantics, especially the domain context provided by browsing and presenting relevant domain specific attributes to specifying queries.
Semantic profiling: capture and management of user interests and usage patterns utilizing the semantics-based organization.
Semantic search: allowing users to use semantics, including domain specific attributes, in formulating and specifying a search and utilizing context and other semantic information in processing the search request.
Semantic Web: concept that web-accessible content can be organized semantically, rather than though syntactic and structural methods.
Semantics: implies meaning and use of data, relevant information that is typically needed for decision-making. Domain modeling (including directory structure, classification and categorizations that organize information) and ontologies (that represent relationships and associations between related terms, context and knowledge) are important components of representing and reasoning about semantics. Analysis of syntax and structure can also lead to semantics, but only partially. Since the term semantics has been used in many different ways, its use herein is directed to those cases that at a minimum involve domain-specific information or context.
Socket: A socket is one endpoint of a two-way communication link between two programs running on the network. A socket is bound to a port number so that the TCP layer can identify the application that data is destined to be sent.
Structure: implies the representation or organization of data and information.
Subclass: a class that is a subset of another class; e.g., a class called “Sherlock Holmes Novels” is a subclass of a class called Book.
Superclass: a class that is a superset of another class; e.g., a class called Book is a superclass of a class called “Sherlock Holmes Novels”.
Syntax: use of words, without the associated meaning or use.

The invention may be implemented in hardware or software, or a combination of both. Preferably, the invention is implemented in a software program executed on a programmable processing system comprising a processor, a data storage system, an input device, and an output device.

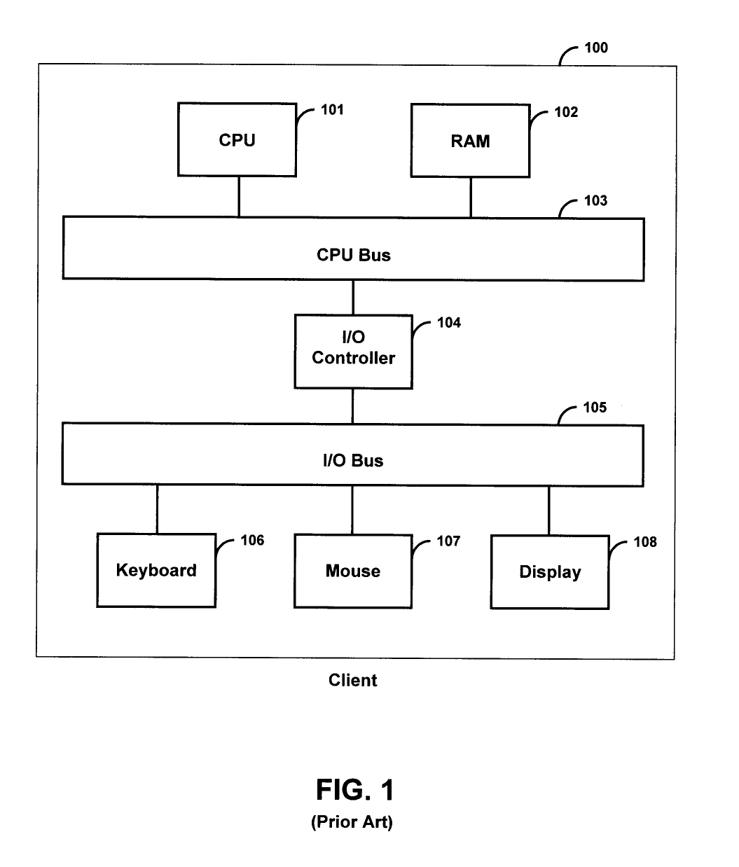

FIG. 1 illustrates one such prior art user device, which is a programmable processing system 100, including a CPU 101, a RAM 102, and an I/O controller 104 coupled by a CPU bus 103. The I/O controller 104 is also coupled by an I/O bus 105 to input devices such as a keyboard 106 and mouse 107, and output devices such as a display 108.

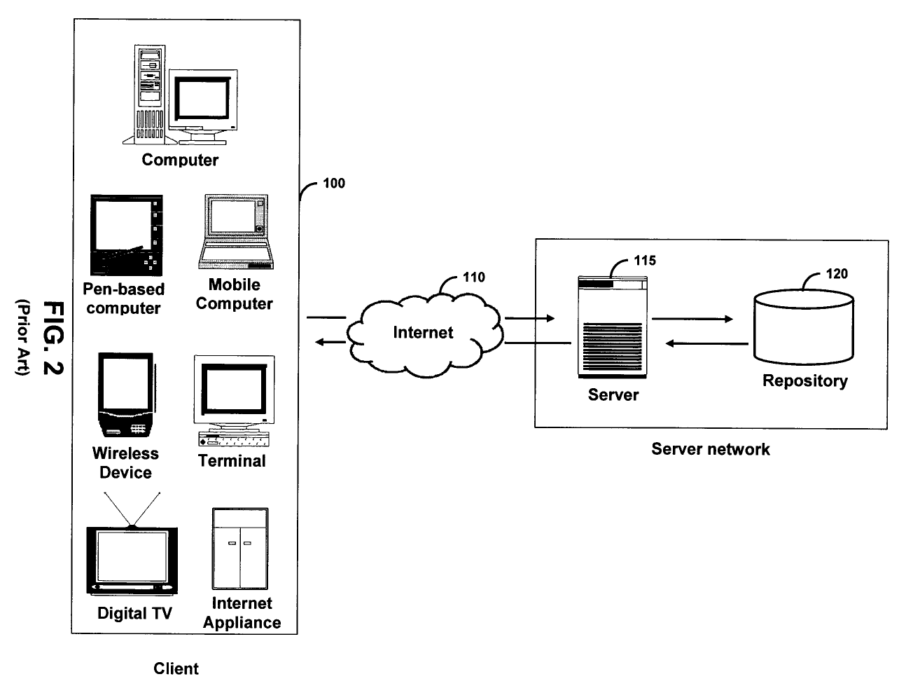

FIG. 2 is a block diagram depicting a prior art network architecture that facilitates the storing, searching and transfer of annotations in accordance with an exemplary embodiment of the present invention. According to one embodiment, an annotation can be created by a programmable client system 100, such as a computer, a pen-based computer, a mobile computer, a wireless device, a terminal, a digital TV of any other appliance and be exchanged over the Internet 110 by a network link that may include telephone lines, DSL, cable networks, TI lines, ATM/SONNET, wireless networks, or any arrangement that allows for the transmission and reception of network signals. In an exemplary embodiment, the annotation system storage is a web server 115 connected to a repository made from a database or a text file 120. Other embodiments are also possible and the repository can be placed in a location that is directly accessible from the server without using a network or a socket connection. The web server includes processors and memory for executing program instructions as well network interfaces. The database can include, among other components, a user information database.

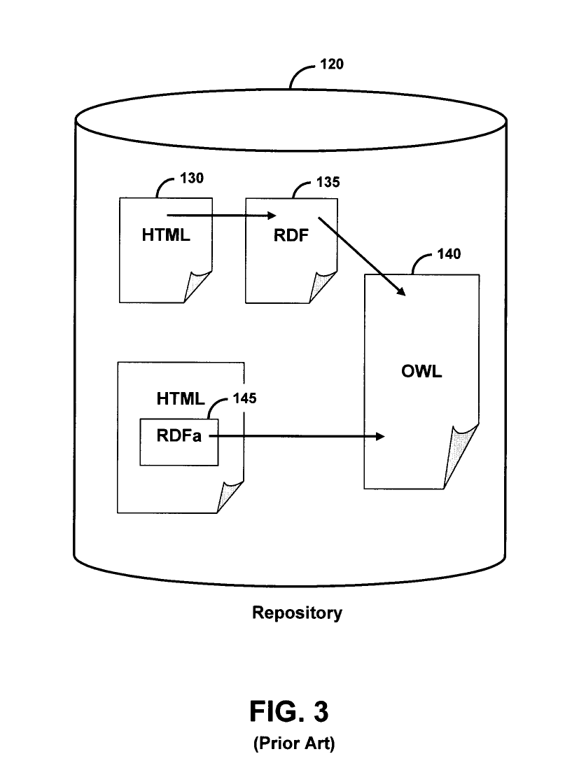

FIG. 3 is a block diagram of a repository structure 120 in accordance with the present invention. The repository is composed of XHTML, RDF and OWL files. The XHTML file 130 may include a reference to an RDF file 135 containing descriptions. It could also include RDF expressions written using a RDFa syntax 145. The RDFa expressions and RDF file could also include references to an OWL ontology file 140. Those skilled in the art will understand that the RDF repository may be represented in many different ways, such as individual tables in one or more relational databases.

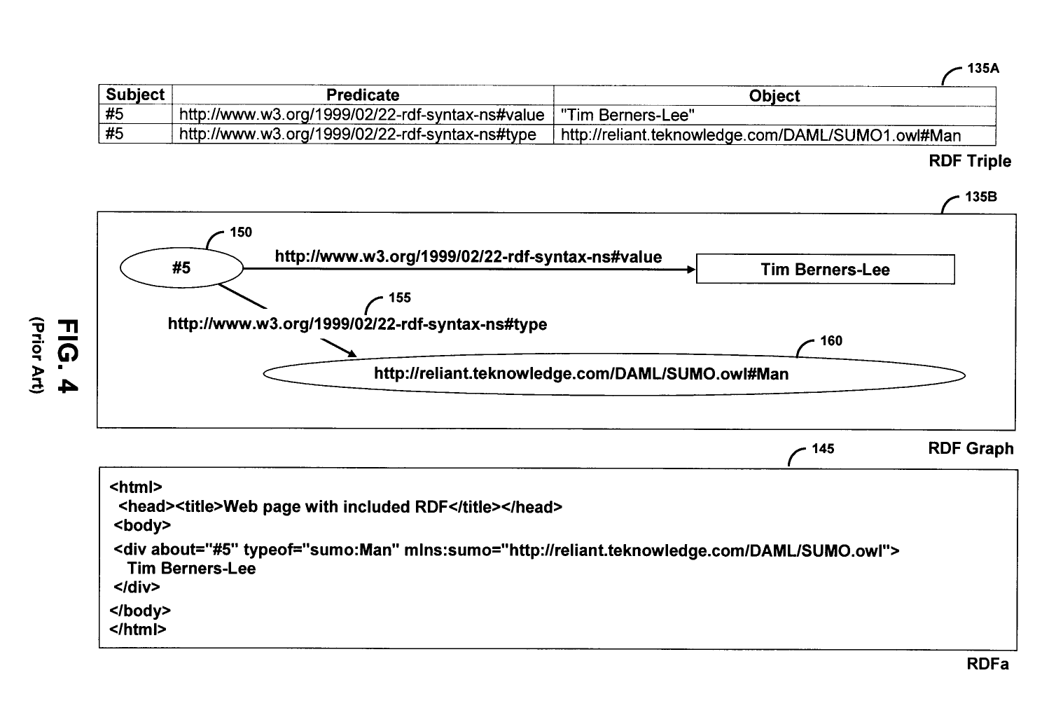

FIG. 4 illustrates an example of prior art RDF triples stored inside a file or database. A RDF triple is a subject, a predicate and an object stored in 3 different data fields 135A. RDF triples can also be expressed as a graph 135B. For example, a resource 150 (subject) can have a relation 155 (predicate) to another resource 160 (object) in order to express that “#5” is a “type” of “Man”. RDF triples can also be expressed in RDFa syntax 145 stored in an XHTML file. A RDF expression can refer to an ontology class 160 residing inside or outside the current repository boundaries. For example, the value “http://reliant.teknowledge.com/DAML/SUMO.owl#Man” represents an absolute URL to a fragment named “Man”. This fragment is a class residing on a server located at “http://reliant.teknowledge.com” inside the “DAML” directory in a file named “SUMO.owl”.

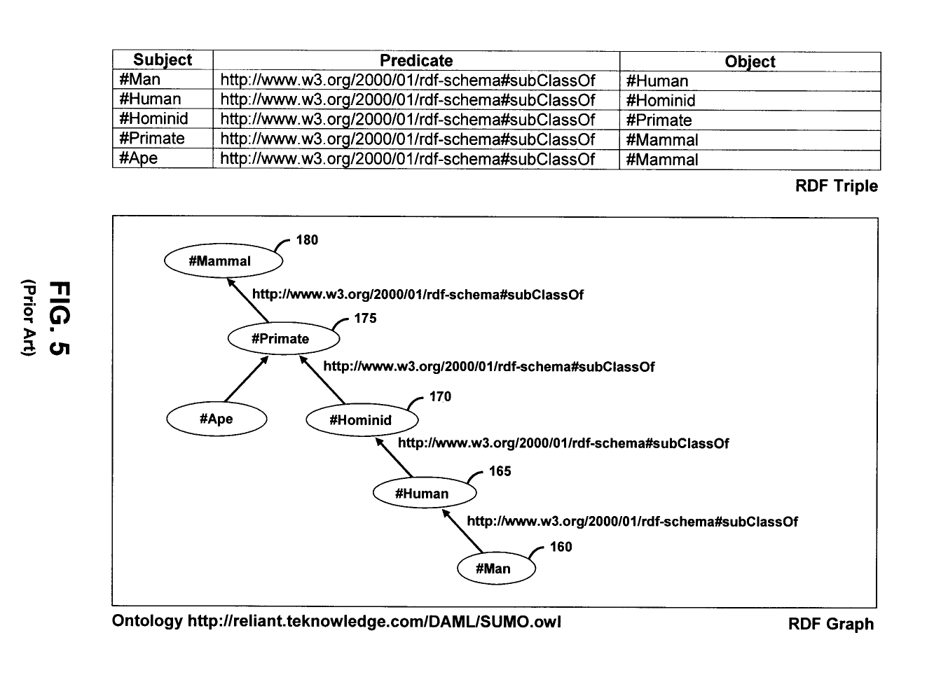

FIG. 5 illustrates an example of the corresponding prior art OWL ontology. The class “Man” 160 is a subclass of “Human” 165, which is also a subclass of “Hominid” 170, which is a subclass of “Primate” 175, and which is also a subclass of “Mammal” 180. Thus, a “Man” is a “Human” related to the “Mammal” species.

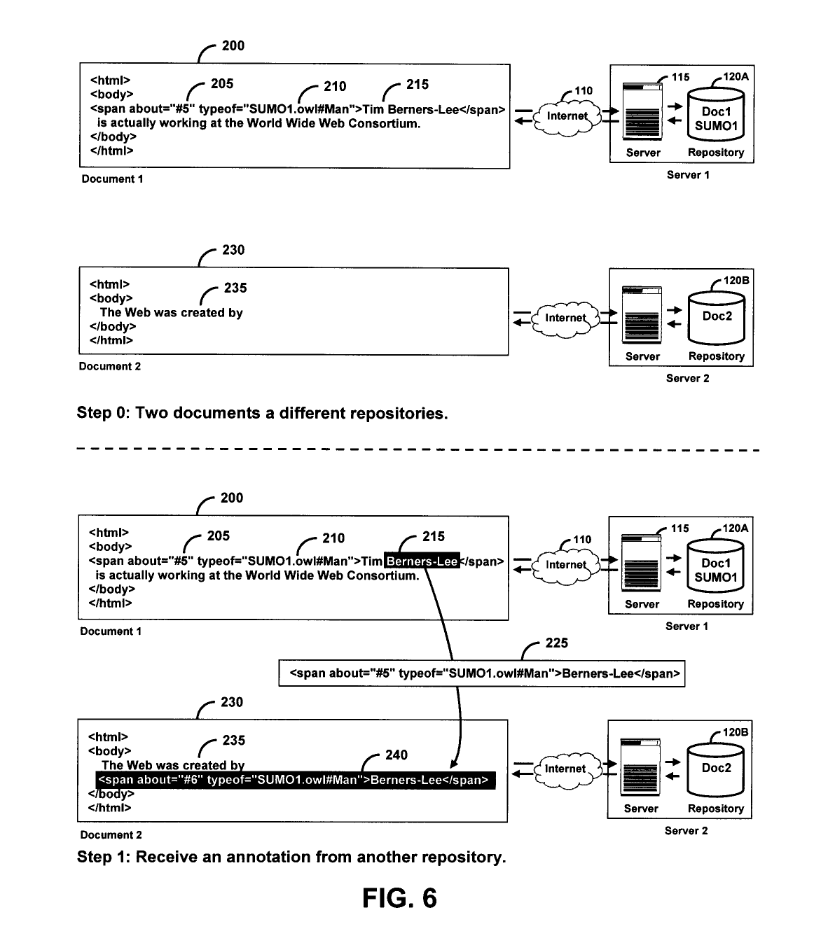

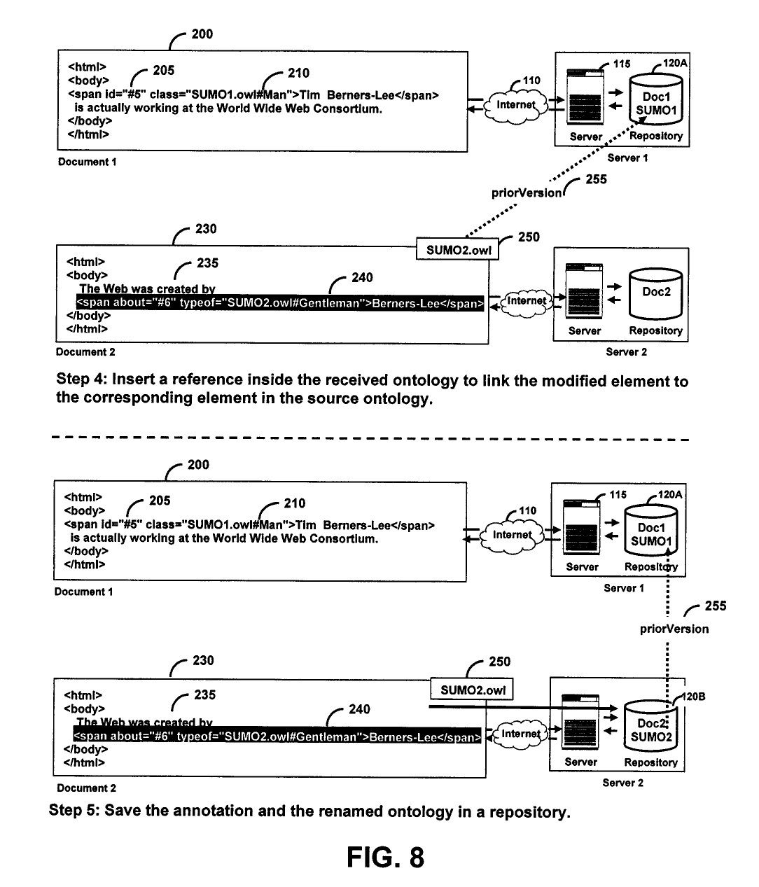

FIGS. 6-8 graphically illustrate the process of enhancing a document with an annotation in order to retrieve the corresponding ontology and creating an alignment between different ontologies in other to assist search engines in locating contents on the Semantic Web.

FIG. 6 illustrates an exemplary embodiment of the present invention where a document 200, residing inside a client system, was downloaded from a server 115 via Internet 110. The document comprises an annotation specifying that “Tim Berners-Lee” 215 has an ID “#5” 205 and that “Tim Berners-Lee” is related to the class “SUMO1.owl#Man” 210. In this example, the class is expressed by a relative URL that specifies that the file “SUMO1.owl” is on the same server as the current document. In this example, the source of the class “Man” 210 is located inside the repository 120A containing its description in OWL format inside a RDF model space named “SUMO1”. The origin of the document 200 is also located in the database 120A but in a different model space named “Doc1”.

A second document is also represented 230. This document is related to its own repository 120B and has no relation with the previous one. This document has no annotation at all 235. The origin of the document 230 is located inside the repository 120B in a RDF model space named “Doc2”.

In Step 1, an annotation is exchanged between the two documents 200 and 230. This exchange can be initiated by a user using the system in accordance with the invention or autonomously by the system. In this example, only the fragment “Berners-Lee” 215 of the original annotation has been copied between the two documents. In order to transfer this annotation, the system will create a temporary annotation 225 using the selected text fragment and the corresponding ID of the source annotation 205. This temporary annotation is then incorporated inside the target document to form a new annotation 240 with its own reference ID (#6).

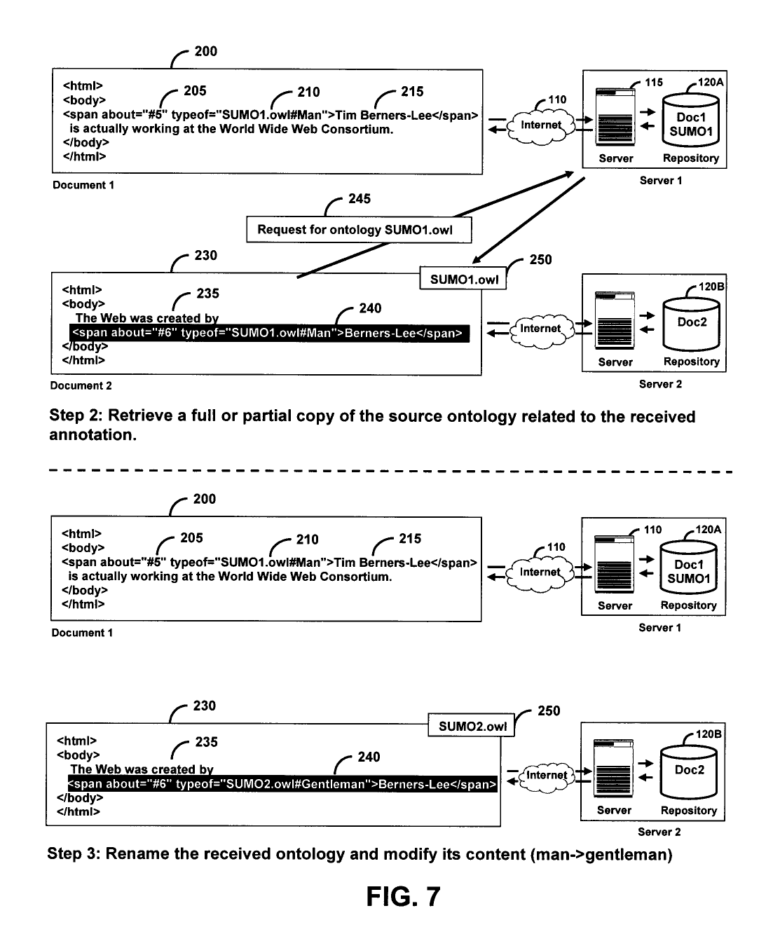

FIG. 7 illustrates the communications between the target document 230 and the original repository 120A.

In Step 2, a request 245 is sent over the Internet to retrieve the ontology (or ontologies) associated with the corresponding annotation 240. Depending of the selected communication protocol, this request could be an HTTP message or a direct remote procedure call (RPC). For example, if the JBDC communication protocol was specified (as “jdbc:mysql://repository.ibm.com/database3modelName5”), the system could establish a direct JBDC connection to the corresponding database, using for example the SPARQL protocol, to retrieve the corresponding ontology. If a XML protocol was specified instead, then a message could be sent to the corresponding web server in order to retrieve the same information in a XML format.

In Step 3, the ontology is renamed in order to differentiate this ontology from the initial source ontology. In this case, the name “SUMO1” is replaced by “SUMO2”. The content of the renamed ontology could then be modified to suit the need of the current user. In this example, the class “Man” was replaced with “Gentleman”.

In step 4, a reference 255 is inserted into the copy of the ontology 250 in order to identify the modified element and relate it to the corresponding element from the original ontology. This reference could be expressed in the OWL syntax using the “priorVersion” attribute:

<rdf:Description
rdf:about=“http://www.server2.com/owl/SUMO2.owl#Man”>

<rdf:type rdf:resource=“http://www.w3.org/2002/07/owl#Class”/>
<rdfs:subClassOf rdf:resource=“#Hominid”/>
<owl:priorVersion
rdf:resource=“http://www.server1.com/owl/SUMO1.owl#Man”/>
<owl:versionInfo>2.0</owl:versionInfo>

</rdf:Description>

The information about the prior version has been directly inserted into the superclass “Man” because this class has been altered by the insertion of the subclass “Gentleman”. The “priorVersion” and the “versionlnfo” attributes indicate that the current class is related to a previous one. It also lets the system keep tracks of any changes made by the different actors. This feature enables enrichment of different ontologies without disrupting any previous definition made in each ontology.

In step 5, the annotation and ontology are saved inside a second repository. The ontology 250 is saved without losing its reference 255 to the original source ontology. The information saved inside the second repository can thus be shared with others in order to repeat steps 1 to 5.

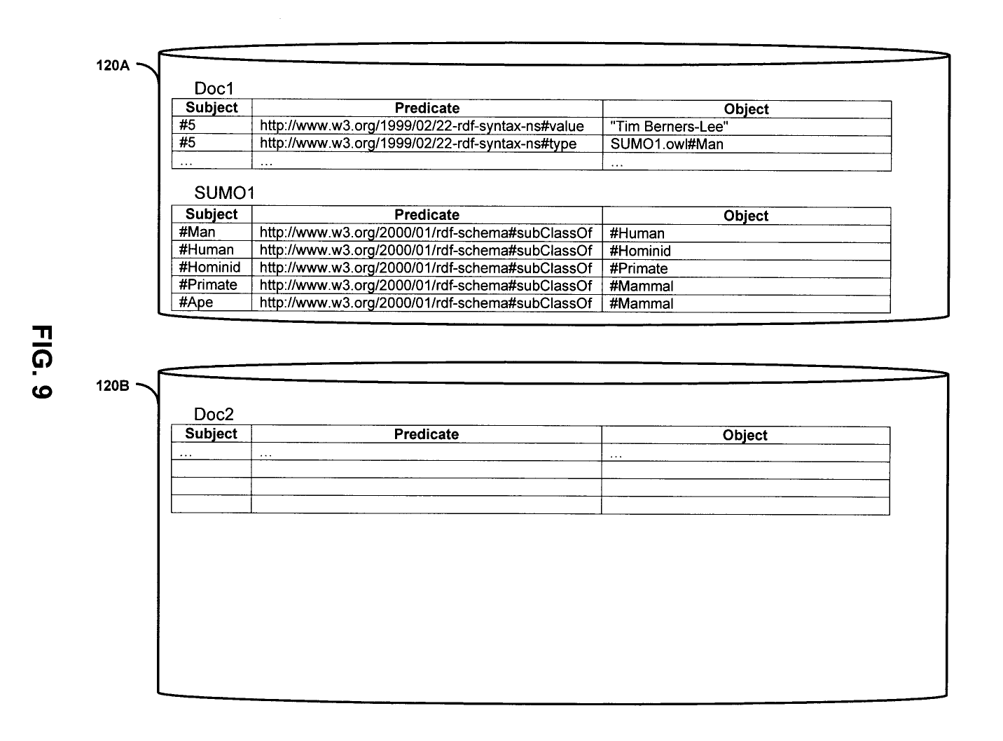

FIG. 9 illustrates the RDF model before the exchange of the annotation. The repository 120A contains the RDF model describing the document. It also contains the ontologies related to this document. The repository 120B does not contain any RDF description.

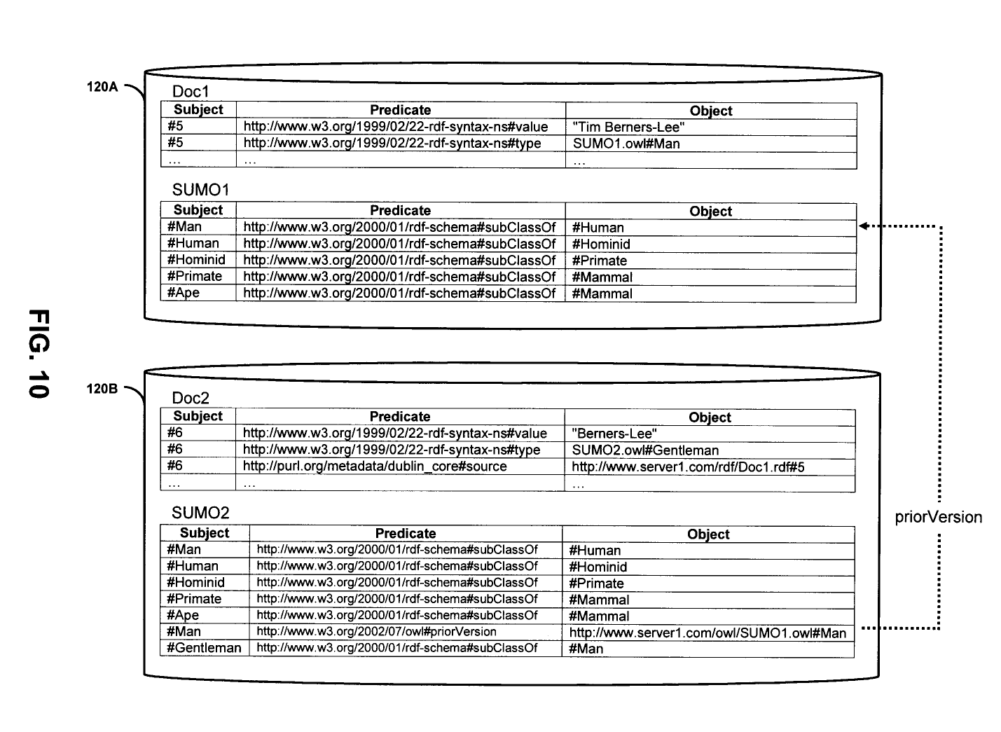

FIG. 10 illustrates the resulting RDF model after the exchange of the annotation. The model “Doc2” 120B contains new RDF expressions stating that the annotation “6” has for value “Berners-Lee” and that “Berners-Lee” is a “Gentleman”.

The model “SUMO2” contains RDF expressions saying that a “Man” is a type of “Human” and that the definition of “Man” is also related to a previous declaration made by another user on a different repository (“www.server1.com/owl/SUMO1.owl#Man”). If we compare the declaration of SUMO1 and SUMO2, we note an agreement in the definition of “Man” as a “Human” representing a type of “Hominid”. Some changes were however made to state a new point of view by saying that there is a type of “Man” called a “Gentleman”.

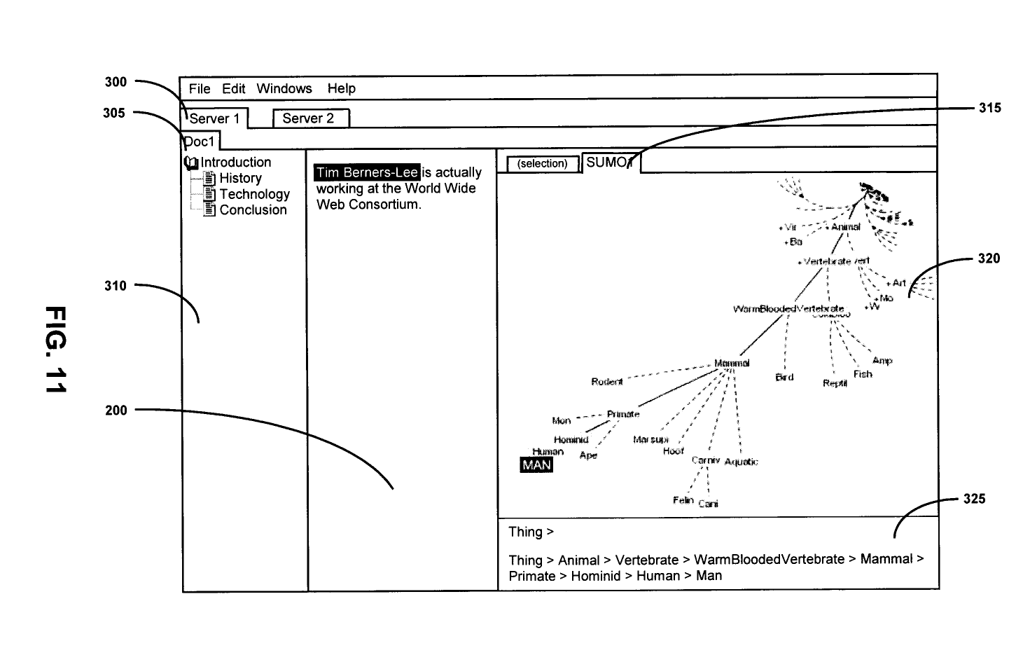

FIG. 11 presents a preferred embodiment for the graphics user interface of the client software in accordance with the invention. This interface can be used to copy annotations between different documents. FIG. 11 illustrates a user that run a program on a client machine in order to read a document located on two different servers. The tab 300 shows that the program is currently connected to “Server 1” and “Server 2”. The actual focus is on the tab “Server 1” which contains only one document 305.

The content of the document 305 is presented in 3 different panes. The left pane 310 presents the hierarchy of the pages contained in this document. The content of each page can be view by selecting the page name inside the hierarchy list. The content of the selected page is presented in the central pane 200 (the content illustrated here also correspond to the content 200 illustrated in FIGS. 6-8). This content could be text, image, video, or any other kind of multimedia object. Objects that are linked to an annotation are identified with a colored background. The value of the annotation can be viewed by moving the cursor directly inside the background area. The content of annotation is then shown in the third pane 315.

The form of the third pane depends of the content of the selected annotation. It could be presented as a list of values, a graphic object or other kind of visual component. In accordance with a preferred embodiment of the present invention, ontologies are presented as hyperbolic trees 320. The choice of representation is not limited to hyperbolic space and any other kind of geometric transformation could be applied to represent an ontology. Visual components other than a tree structure could also be used.

Each annotation can be associated with many different ontologies. In the preferred embodiment of the present invention, each ontology is however presented in a different pane 315.

An ontology can refer to many other ontologies. In the preferred embodiment of the present invention, the user can navigate iteratively from one ontology to another by clicking on a plus “+” icon representing external ontologies inside the tree structure.

In FIG. 11, the lower section 325 of the ontology pane is used to present information about the hierarchy of the current selected ontology classes (ex: Thing>Entity>Physical> . . . ). The use of this information is not mandatory. It is simply used here as a way to compensate for the lack of space in the hyperbolic tree representation.

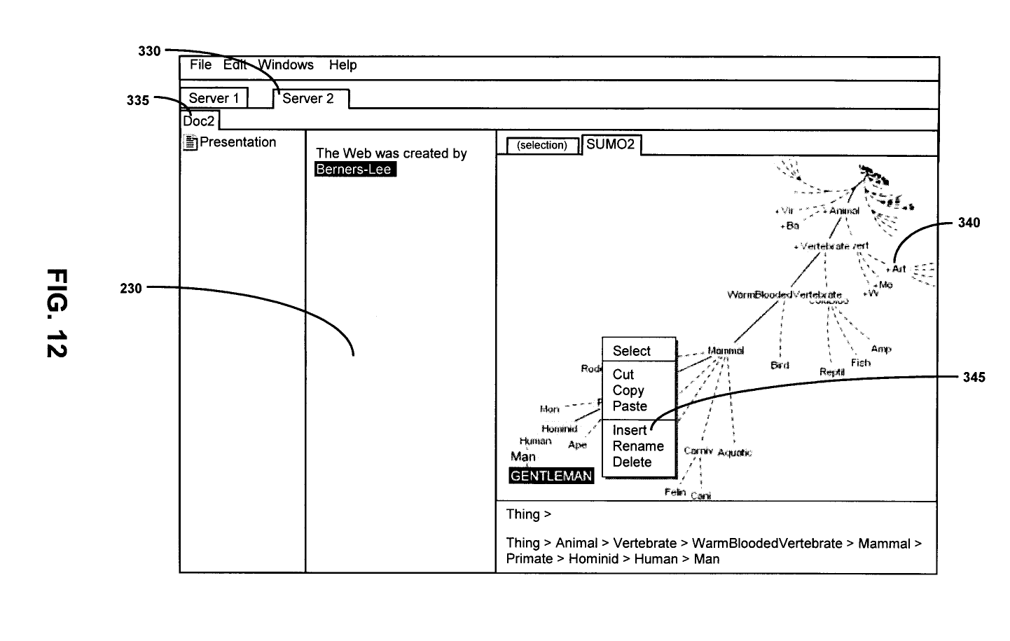

FIG. 12 illustrates the same graphics user interface with a different tab selected (“Server 2”) 330. It illustrates a user who has just copied and pasted an annotated text (“Berners-Lee” coming from “Doc1” in FIG. 11) in a different document (“Doc2” located in the “Server2” in FIG. 12) 335. A colored background represents the annotation. When moving the cursor over the annotation, the ontology associated with this annotation is downloaded and copied as explained above (FIG. 7). The newly copied ontology is represented in the ontology pane 340 in the same way as before (FIG. 11). The contextual menu 345 illustrates the possibility for the user to modify the structure of the newly downloaded ontology in order to better represent its own conception of the universe. As explained above, every new modification made by the current user is followed by a “priorVersion” added to the corresponding element definition in order to keep track of all changes made inside this ontology. In this case, the class “Gentleman” was added under the class “Man”.

In the present embodiment of the present invention, the document containing the annotation can be used directly on the web as a normal HTML page. The annotation will be simply seen as a text containing RDFa expressions. Other embodiments are also possible and the RDF expressions could be used to generate an external RDF file containing all the corresponding descriptions.

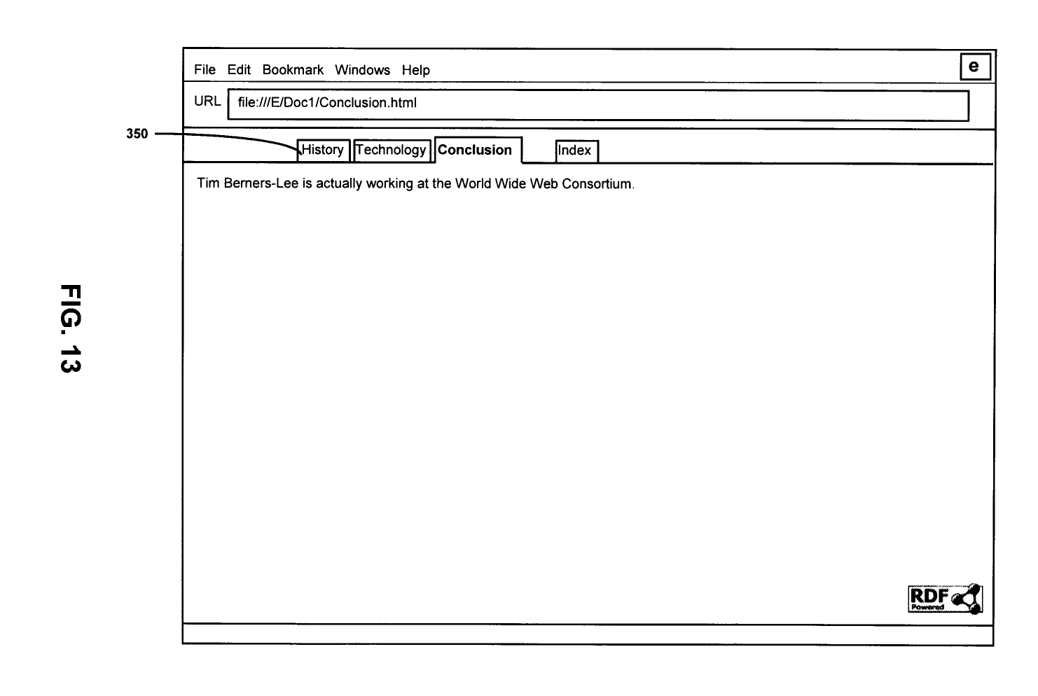

FIG. 13 presents a preferred embodiment for HTML page output. Web pages are built automatically by the system using the information contained in the selected document. For example, the illustration of FIG. 13 corresponds to the page seen previously in FIG. 11. The top of the page is occupied by a menu 350 illustrating the position of the HTML page in the current directory.

In an embodiment where the RDFa statements are not directly included in the HTML pages, the RDF expressions should be made easily accessible inside an external file. A link to this RDF file should also be directly inserted into the <head> section of each HTML page in order permit the file to be located. For example, the page “Conclusion.html” should be linked to a RDF file named “Conclusion.rdf” using this code:

<head>

<link rel=“meta” type=“application/rdf+xml”
href=“Conclusion.rdf” />

...

</head>

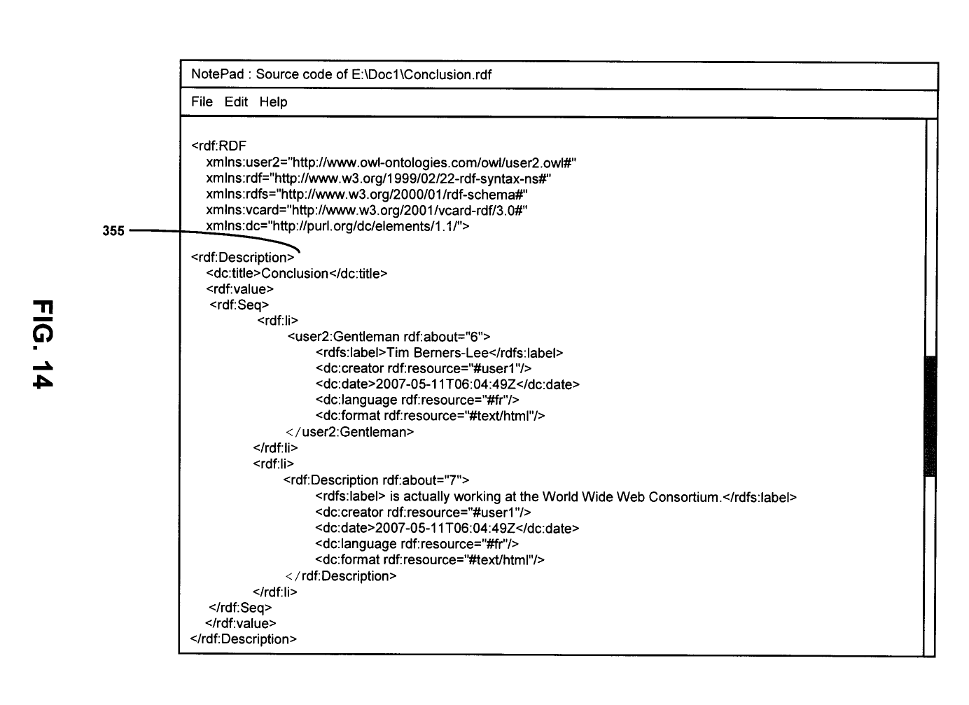

FIG. 14 illustrates the content of a RDF description file named “Conclusion.rdf” that describes the content of the web page named “Conclusion.html” (already presented in FIG. 13). The descriptions 355 are built in a way to let software agents access the semantic value of web contents. For example, the description of FIG. 14 stipulates that “Tim Berners-Lee” is a “Gentleman” and this concept is related to a specific ontology. A user (“user1”) has created this description on a specific date. Using this reference to “Gentleman”, an agent could locate the “priorVersion” attribute to identify different ontologies related to the same concept as this one. The agent could also use the same strategy to locate other content related to this concept by locating all indirect references to the superclass “Man” (or other reference to any “priorVersion” attribute related to “Man”).

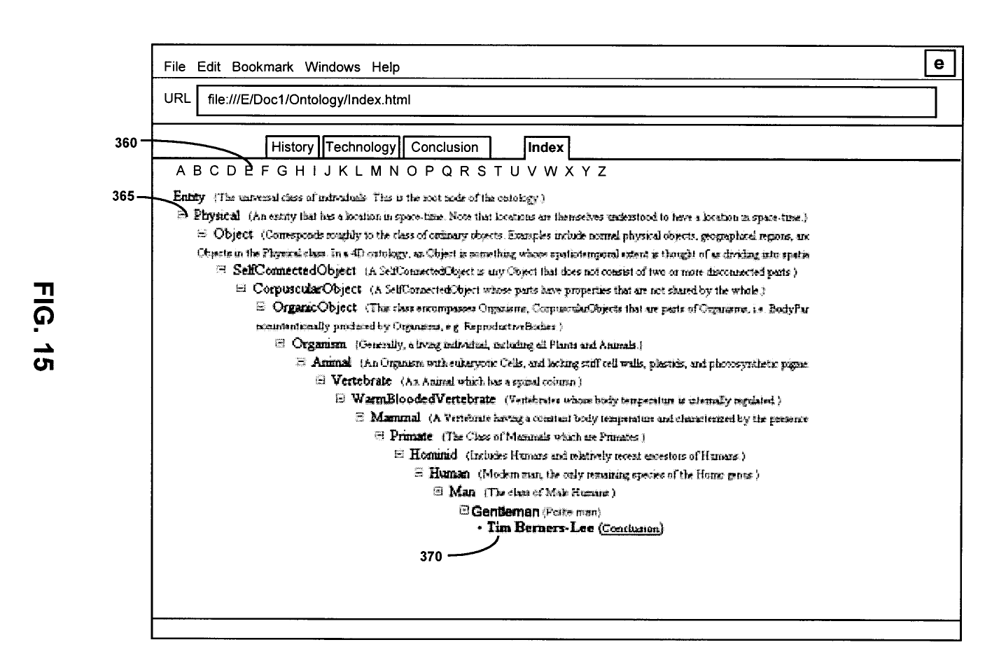

FIG. 15 illustrates a preferred embodiment for an HTML index created by the system to summarize the entire web site. This index takes the form of a hierarchy of concepts 365 enumerating the position of each concept inside the web site. The index is constructed automatically by the client software using ontology classes that are linked to annotations and by indexing all web pages where these annotations occur. The ontology classes are represented in sorted order, from the most general concept down to the particular one in the form of a hierarchy list. The lower end 370 of each branch presents the words related to the annotation and a link to the page where this annotation is located. The index page has also an alphabetical menu 360 that gives direct access to the ontology classes using the first letter of their name. This way, the end user can easily find all the content already annotated in the different web pages of the site.

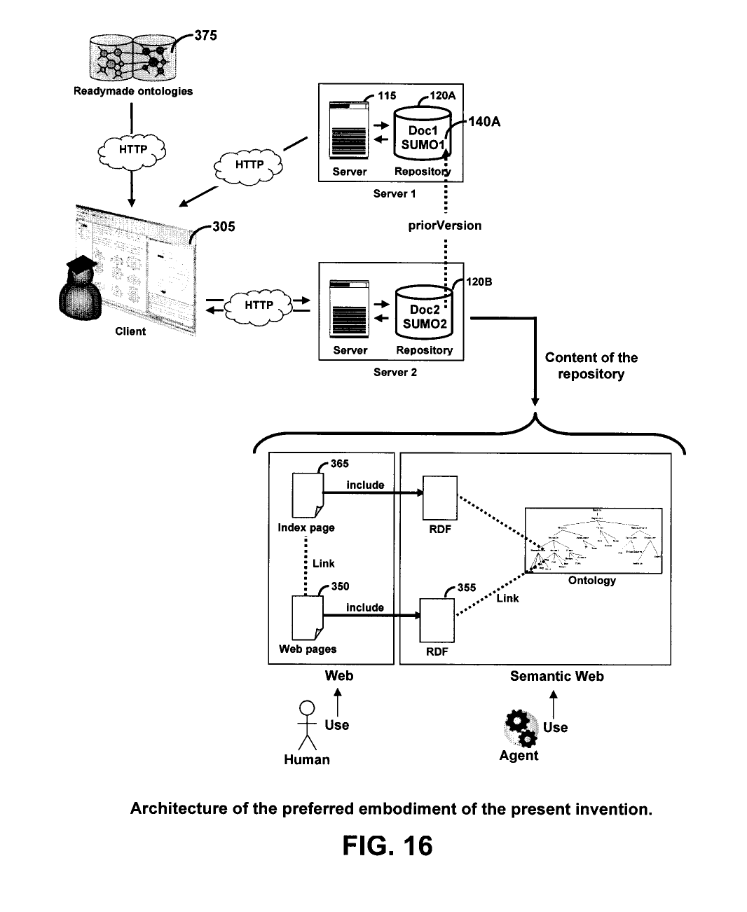

FIG. 16 illustrates the architecture of the preferred embodiment of the present invention. The application 305, running as a client software, is connected to a distant repository 120B. This client application 305 is also connected to one or many other repositories 120A in order to let the user copy and paste contents from different documents. As explained above, the main goal of this application is to exploit the annotations that have been exchanged between users in order to create indirect links between ontologies. If an annotation (that already contains a reference to an ontology class) is moved between two different documents, then this information is used by the system to make a local copy of the ontology and to create an indirect link (“priorVersion”) between the new ontology elements and their original counterparts in the source ontology (as shown in FIG. 10). The indirect links created between different ontology classes constitute to a global ontology that can be used afterward by search engines to locate the web contents. As explained above, the communication protocol between the client software and the repository can take many different forms (ex: a remote procedure call using SPARQL on top of JBDC to access a SQL database). In the preferred embodiment, the communications protocol takes the form of a simple HTTP request to a web server.

Using the convenience of the graphic user interface, the user can choose to create his own ontology classes or download readymade ontologies 375 before modifying them for his own use. Readymade ontologies can simply be downloaded using an FTP or HTTP protocol via some web services like Google (http://www.google.com), Swoogle (http://swoogle.umbc.edu) or Ontaria (http://www.w3.org/2004/ontaria/).

The content of the repository is made by web pages and ontology(ies) that can be made directly available on the web. Any end user could use a web browser to navigate between the different web pages 350 using the navigation menu located at the top of all pages produced by the client system (as shown in FIG. 13). The web user can also access the index page 365 in order to find the contents related to some specific ontological concept (as shown in FIG. 15). The web pages, as well as the index page, include RDF descriptions 355 that can be used by agents or search engines to locate concepts or ontology classes related to those pages. Ontologies can thus be used by software agents as the main entry point to start a search.

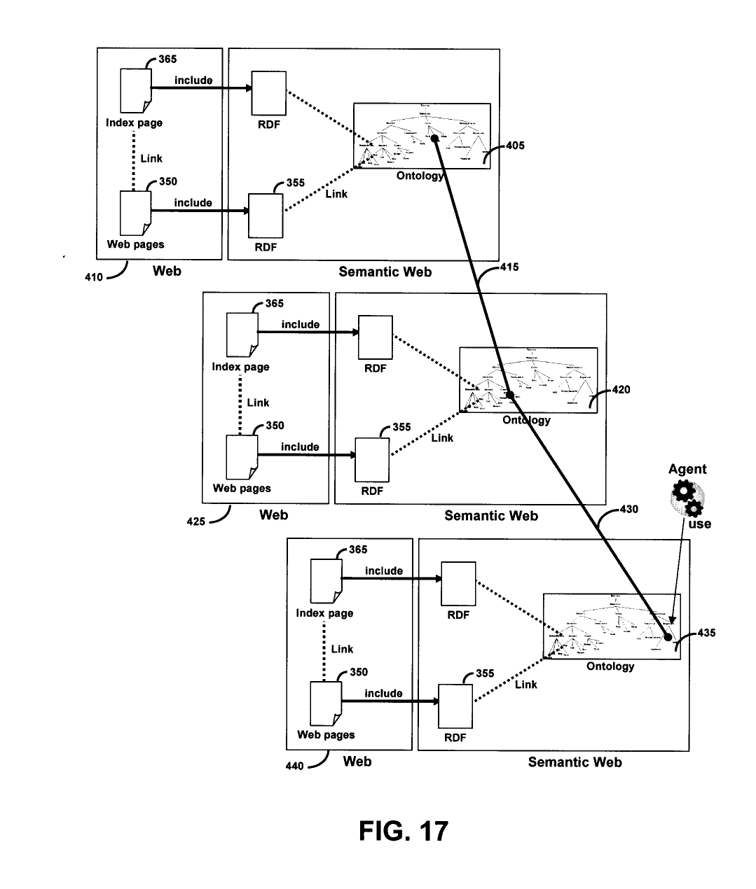

FIG. 17 graphically summarizes an alignment of ontologies that was made using the present invention. Each ontology is physically independent from each other so the change made in one ontology is not propagated to all others. This disposition lets different actors state different opinions without requesting a synchronization mechanism. The alignment of ontologies is obtained by the indirect links that connect the corresponding class in each ontology. The fact that these ontologies were used by different people sharing at least one common content (annotation) guaranties that the shared concepts should be relatively close to each other. The software agent can simply follow these links 430 415 to map the agreement (or disagreement) between the different authors of these ontologies. These links will also permit the mapping of parallel or different evolutions of the shared concepts.

Every copy of the shared ontology could be modified by incorporating parts from others ontologies. If these parts already have some indirect link to other ontologies, then the overall effect will be a dramatic increase in the overall size of the alignment grid. This huge grid could then used by software agent to optimize their search.

Moreover, the fact that these ontologies where crafted while using an annotation will enhance the probability that the final ontologies will be built as “application ontologies” rather than “top-level ontologies”. This will compensate for the scarcity of “application ontologies” on the Semantic Web (i.e. most ontologies are created by knowledge experts that do not necessarily recognize the practical needs of common end users).

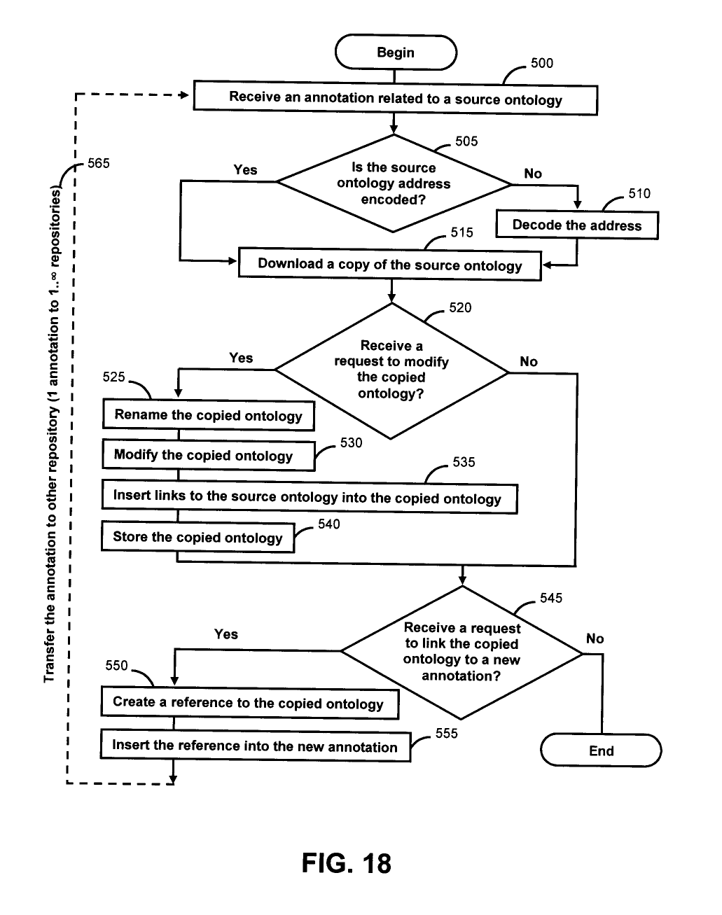

FIG. 18 graphically summarizes the process of using annotations to achieve ontology alignment. The method is presented in steps summarizing the illustrations shown in FIGS. 6-8. The method starts by receiving an annotation related to a source ontology 500. If the source ontology address is encoded in a special format 505, then this address is decoded before using it 510. A copy of the source ontology is then retrieved 515. If a request to modify the copied ontology is received 520, then the ontology is renamed 525 before any modification is made to it 530. Every modified element inside this ontology is then tagged with a reference that links this element to the original element in the source ontology 535. The modified ontology is then stored in a repository 540. If a request is received to link the copied ontology to a new annotation 545, then a reference is made to the modified ontology 550 before being inserted into the new annotation 555. This new annotation could be shared 565 with others in order to repeat this same cycle again and again.

One of ordinary skill in the art would recognize that modifications and extensions might be made which are within the scope of the present invention. For example, the process of producing documents can be separate from the client software and be executed by a different application running on a different machine. The process of retrieving a copy of an ontology can be modified to suit the need of a peer to peer network or an integrated system working with or with a multitude of repositories located on the server.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method of aligning ontologies using annotation exchange in a computer environment in which a plurality of storage media are connected for intercommunication over a plurality of networks, each storage medium storing annotations received from other storage media and ontologies associated with each said annotation, the method comprising the steps of:
receiving at a first storage medium an annotation associated with a source ontology;
retrieving at least a partial copy of said source ontology;
renaming said retrieved ontology;
modifying the renamed ontology in accordance with each element changed by an actor that modifies at least one element of the renamed ontology;
inserting a reference in said modified renamed ontology that links said each said changed element to a corresponding element in said source ontology, in order to track a difference between the renamed ontology and the source ontology; and
storing said modified renamed ontology.

2. The method of claim 1, wherein storing said modified renamed ontology comprises storing said modified renamed ontology on the first storage medium.

3. The method of claim 1, wherein retrieving at least a partial copy of said source ontology comprises a first step of decoding an address of the source ontology.

4. The method of claim 1, wherein modifying the renamed ontology in accordance with each element changed by an actor comprises processing changes made manually, semi-manually, automatically, or automatically in accordance with guidance rules.

5. The method of claim 1, further comprising generating a document using the content of the said annotation or said modified renamed ontology.

6. The method of claim 5 wherein creating said document comprises creating any one of: a web page; an image; a text document; a video; a multimedia document; or an XML document.

7. Computer-readable medium containing tangibly embodied executable code that when executed by a user device instantiates a user interface adapted to be used by said actor to perform the method as claimed in any one of claims 1-6 .

8. Computer-readable medium containing tangibly embodied executable code that when executed by a server enables an actor to perform the method as claimed in any one of claims 1-6.
